(19) United States
(12) Patent Application Publication
(10) Pub. No.: US 2025/0231617 A1
(43) Pub. Date: Jul. 17, 2025

(54) ADAPTING OPERATION OF DEVICE BASED ON PLACEMENT

(71) Applicant: Telefonaktiebolaget LM Ericsson (publ), Stockholm (SE)

(72) Inventors: Andreas KRISTENSSON, Södra Sandby (SE); Gang ZOU, Lund (SE)

(21) Appl. No.: 18/849,478

(22) PCT Filed: Mar. 25, 2022
(86) PCT No.: PCT/EP2022/057962

§ 371 Date: Sep. 21, 2024

(51) Int. Cl. G06F 3/01; G05B 15/02; H01Q 3/24; H01Q 21/20; H04B 7/0404

(52) U.S. Cl. CPC G06F 3/012; G05B 15/02; H01Q 3/24; H01Q 21/20; H04B 7/0404

(57) ABSTRACT

A device and method therein are provided for adapting its operation such that operation power and directional capabilities can be optimized by using the knowledge about the placement and/or directionality of the device with respect to what the device is being placed on, or attached to, or worn by. Embodiments herein estimate a device's spatial placement and/or directionality in relation to a user based on obtained inertial measurement data measured by one or more sensors of the device and adapts the operation of the device based on the estimated placement and/or directionality of the device and further adapt its operation by enabling or disabling said device's antenna arrays accordingly for low power operations and optimal directional capabilities.

### TECHNICAL FIELD

Embodiments herein relate to a device and method therein for adapting operation of the device. In particular, they relate to a smart wearable device and method therein for adapting operation of the wearable device based on its placement.

### BACKGROUND

Smart wearable devices exist both as products and concepts. For examples, US20130311132 discloses a wearable computing device, i.e. a smart wig comprising a sensor, a processing unit and a communication interface that is coupled to the processing unit for communicating with other devices. The wearable computing device may communicate with several client devices and may control these devices or be controlled by these devices. Google has developed a smart hat having a front facing camera and is designed to be worn with brim facing forwards i.e. a classic style for its functionality to operate properly. Photos and video could be shared via social media to a users' friends and even allow for live interaction with another user.

Many types of devices or items are becoming connected as internet of things (IoT) devices, allowing them to communicate with each other. Smart wearable devices which allow a user to address and interact with IoT devices in an intuitive way are developing. One idea is that a user holds or wears a directional Bluetooth capable device comprising an array of antennas. Directional Bluetooth capable devices can use direction finding feature to determine the direction of a Bluetooth signal. The core of the direction finding specification relies on two methods called the angle of arrival (AoA) and angle of departure (AoD). Both methods rely on at least one of the Bluetooth devices having an array of antennas and being able to receive or transmit the Bluetooth signal with phase shifting between the different antennas. With AoA or AoD technologies, it is possible to detect the angle from an antenna array in a smart headwear, e.g. a hat or a cap etc. to an IoT device it communicates with. Therefore, it is possible to detect whether that IoT device is in front of the person wearing the smart headwear.

However, operation power and directional capabilities still need to be improved for these directional Bluetooth capable devices.

### SUMMARY

It is therefore an object of embodiments herein to provide a device and method therein for optimizing its operation and directional capabilities.

According to one aspect of embodiments herein, the object is achieved by a device and method therein for adapting its operation. The device comprises one or more sensors, a controller, a processor and a memory. The device is configured to obtain inertial measurement data by the one or more sensors. The device is further configured to estimate, by the processor, placement and/or directionality of the device with respect to what the device is being placed on, or attached to, or worn by, based on the obtained inertial measurement data. The device is further configured to adapt, by the controller, the operation of the device based on the estimated placement and/or directionality of the device.

According to some embodiments herein, the device may comprise a RF receiver and/or a transmitter with one or more antenna arrays or antenna sub-arrays, e.g. Bluetooth antenna array, for interacting, positioning or communicating with other equipment or devices, e.g. IoT devices. The one or more antenna arrays or antenna sub-arrays are distributed at different locations of the device. The device is configured to adapt the operation of the device based on the estimated placement and/or directionality of the device by being configured to enable or disable one or more antenna arrays or sub-arrays based on the estimated placement and/or directionality of the device with respect to what the device is being placed on, or attached to, or worn by, in order to interact, position or communicate with the other equipment in a certain direction.

According to some embodiments herein, the device may be a headwear device comprising any one of a smart cap, a smart wig, a smart glasses, a smart hat, a smart helmet, a smart scarf, a smart headband, a smart hair band etc.

According to some embodiments herein, the device may be a headset. The device is configured to adapt the operation of the device based on the estimated placement and/or directionality of the device by being configured to assign right and left speaker output based on the estimated placement and/or directionality of the headset with respect to a user the headset is worn by.

According to some embodiments herein, the device may be a generic bike light. The device is configured to adapt the operation of the device based on the estimated placement and/or directionality of the device by being configured to adapt the bike light as a front light or a rear light based on the estimated placement and/or directionality of the bike light with respect to a bike the bike light is being placed on or attached to.

In other words, by using the knowledge about the pose of a user of a device, i.e. the placement and/or directionality of the device with respect to what the device is being placed on, or attached to, or worn by, embodiments herein may deduce the device's, e.g. a headwear device's spatial placement and/or wearing style in relation to the user pose and further optimize the operation of said device's Bluetooth antenna array accordingly for low power consumption and optimal directional capabilities.

Embodiments herein enable for a smart headwear device such as a smart cap with Bluetooth antenna array(s) to be worn both with brim facing forwards, i.e. a normal or classic style, or brim facing backwards, i.e. a backwards style, and also with brim in various degrees in there between, e.g. a brim on side. Analyzing inertial measurement data from said device will allow for enabling and disabling antenna arrays in such a way that it is only the front facing antenna arrays, in relation to the user pose, that are enabled to communicate with an IoT device or other equipment in a certain direction relative to the user pose so that low power operations and optimal directional capabilities can be achieved.

Therefore, embodiments herein provide an improved device and method therein for optimizing its operation and directional capabilities.

### BRIEF DESCRIPTION OF THE DRAWINGS

Examples of embodiments herein are described in more detail with reference to attached drawings in which:

FIG. 1 shows a schematic block view of a device according to embodiments herein;

FIGS. 2a and 2b are simplified schematic views of a user wearing a headwear device according to embodiments herein; and

FIG. 3 shows a flowchart of a method according to embodiments herein.

### DETAILED DESCRIPTION

As discussed in the background, although some ideas and principles have been discussed for smart wearable devices which allow a user to address and interact with IoT devices in an intuitive way, there is no discussions or disclosures on how Bluetooth antenna arrays in a device could be optimized for low power operations and optimal directional capabilities depending on said device's spatial placement or wearing style in relation to a user pose.

According to embodiments herein, a device and method therein are provided for adapting its operation such that operation power and directional capabilities can be optimized by using the knowledge about the placement and/or directionality of the device with respect to what the device is being placed on, or attached to, or worn by. Embodiments herein may deduce a device's, e.g. a headwear device's, spatial placement and/or wearing style in relation to a user pose and further optimize said device's antenna arrays accordingly for low power operations and optimal directional capabilities.

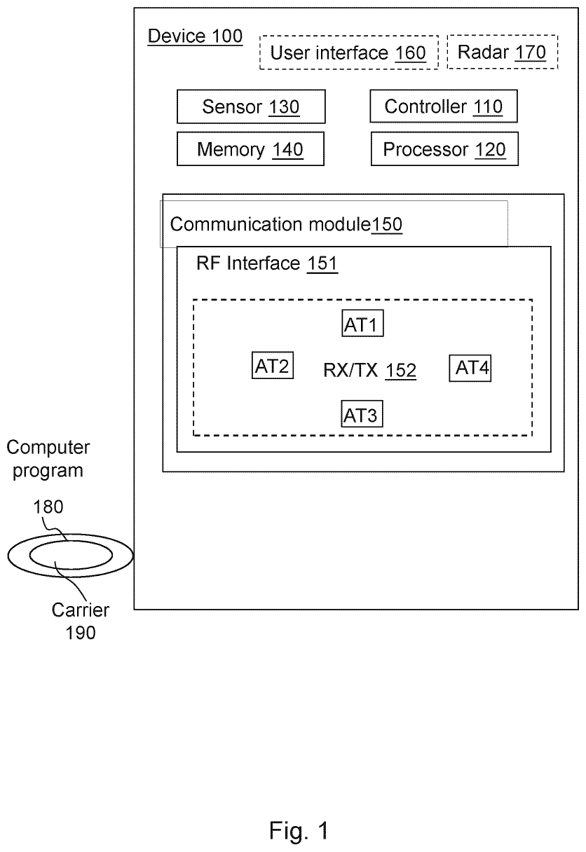

FIG. 1 shows a schematic block view of a device 100 according to embodiments herein. The device 100 comprises a controller 110, a processor 120, one or more sensor 130, a memory 140 and a communication module 150.

The controller 110 is configured to control the overall operation of the device 100. The processor 120 is configured to analyze, process commands, instructions, data etc. The memory 140 is configured to store data, device settings, information, computer-readable instructions or codes etc.

The communication module 150 is configured to enable communication with other devices or equipment, e.g. IoT devices, for controlling or interacting with the IoT devices or interacting with a server for receiving content, instructions and/or settings or other data.

The communication module 150 comprises a radio frequency (RF) communications interface 151. The RF interface 151 may be a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. Alternatively, the RF interface 151 may comprise a cellular communications interface such as a fifth generation (5G) cellular communication interface, a Long Term Evolution (LTE) interface, a Global System Mobile (GSM) interface and/or other interface commonly used for cellular communication.

The RF interface 151 may also or alternatively be based on visible light communication (VLC).

The RF interface 151 may comprise a receiver or a transmitter or both, i.e. a transceiver RX/TX 152 with one or more antenna arrays or antenna sub-arrays AT1, AT2, AT3, AT4. For example, for the Bluetooth™ interface, the RF interface 151 may comprise a Bluetooth receiver and/or transmitter which can receive/transmit radio signals via the one or more antenna arrays or antenna sub-arrays.

The one or more sensors 130 may comprise an inertial measurement unit (IMU) which measures and reports a body's specific force, angular rate, and sometimes the orientation of the body, using a combination of accelerometers, gyroscopes, and sometimes magnetometers. The one or more sensors 130 may comprise other sensors capable of detecting or estimating placement of a smart headwear from analyzing the data captured by the sensors. The one or more sensors 130 may further comprise a light input device, such as an ambient light sensor or a camera, for registering light waves.

The device 100 may optionally comprise a user interface 160 for receiving commands from a user. Such user interface 160 may also be arranged to provide data or information to a user.

The user interface 160 may comprise one or more buttons. One such button may be arranged to activate the device 100, or a particular function in the device 100, upon receiving a touch input.

The device 100 may be a wearable device such as a headwear device. For example, the device 100 may be associated to a headwear such as a cap, a hat, a helmet, a wig, a pair of glasses, a headband, a hair band, a scarf etc., by varies ways, such as integrating, sewing, molding, attaching etc., to form a smart headwear device. That is the device 100 may be a headwear device comprising any one of a smart cap, a smart wig, a smart glasses, a smart hat, a smart helmet, a smart scarf, a smart headband, a smart hair band etc.

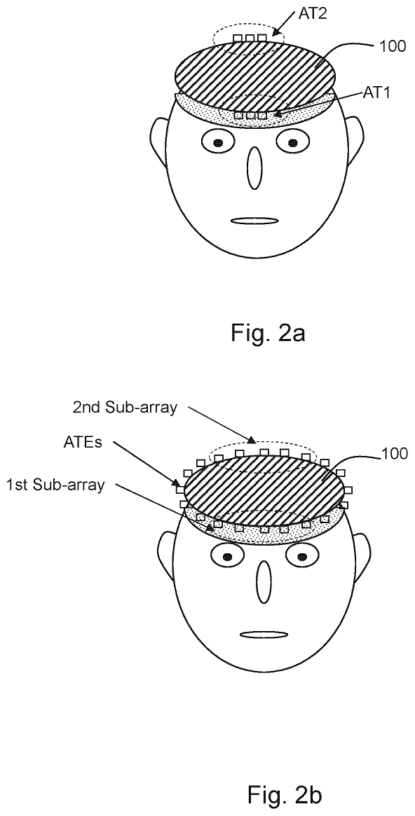

The placement of the one or more antenna arrays or antenna sub-arrays on a smart headwear may vary. For example, a smart headwear e.g., a cap, may include multiple antenna arrays, one antenna array AT1 may be located on the brim side of a cap, another antenna array AT2 may be located on the rear side of a cap, as shown in FIG. 2a, where the device 100 is shown as a cap and a user is wearing it on his head with the brim facing forward.

For another example, a smart headwear may include a single antenna array whose antenna elements (ATEs) are distributed round the edge of the said headwear, e.g. an uniform circular array ATEs, as shown in FIG. 2b. The antenna array can then be divided into several sub-arrays, for examples, the antenna elements located on the brim side of a cap may be a first Sub-array, the antenna elements located on the rear side of a cap may be a second Sub-array. The smart headwear device may then enable different sub-arrays to scan the space around the user wearing the smart headwear device. For example, when an IoT device, i.e. an object, transmits radio signals that arrive at the device 100 as a locator, using the geometry of the antenna array in the device 100, the AoA of the signals with respects to the device 100 can be calculated. Based on the AoA information, the direction of the object relative to the locator can be estimated.

Embodiments herein enables for a smart headwear device such as a smart cap with directional Bluetooth antenna array(s) to be worn both with brim facing forwards, i.e. a normal or classic style, or brim facing backwards i.e. a backwards style, and also with brim in various degrees in there between, e.g. brim on side. For example, by analyzing IMU data from said device will allow for enabling and disabling antenna arrays in such a way that it's only the front facing antenna array, e.g. the antenna array AT1 shown in FIG. 2a or the 1st Sub-array shown in FIG. 2b, in relation to the user, that are enabled so as to optimize said antenna array for front facing usage to allow the user interfaces, interacts or communicates with the objects in front of himself/herself. It is also possible that only the right side antenna array, or only the left side antenna array, or only the back side antenna array is enabled for different use cases.

It should be noted that the device 100 may be a single device comprising all function modules such as the controller 110, the processor 120, the communication module 150, the one or more sensors 130, the user interface 160 etc. as shown in FIG. 1, or the function with pose estimation and intelligent interfacing with nearby devices may be comprised in or may be distributed across several devices and apparatuses, such as a mobile device, smart watch, other wearable device, other nearby system such as smart speaker, etc.

The device 100 and method therein for adapting its operation to optimize operation power and directional capabilities will now be described in detail with some example embodiments.

According to embodiments herein, in order to know the placement and/or directionality of the device 100 with respect to what the device 100 is being placed on, or attached to, or worn by, the device 100 is configured to, e.g. by means of the one or more sensor 130 being configured to, obtain inertial measurement data.

For example, when a user puts on the device 100, e.g. a smart headwear device with brim facing forwards, i.e. a classical style, the user starts the smart headwear device e.g. by pushing a power button on said headwear device, then the smart headwear device starts and records IMU and/or other sensor data. The smart headwear device may also be automatically started by the device itself using nearness sensors, pressure sensors, mechanical constructs, etc., without having the user to push a specific on-off button. Also Voice commands and Gesture commands might be utilized to start the device For example, the smart headwear device may detect by itself that it was placed on the user's head and start recording IMU and/or other sensor data for estimating wearing style or position of said headwear device in relation to its user.

According to embodiments herein, the device 100 is further configured to, e.g. by means of the processor 120 being configured to, estimate the placement and/or directionality of the device 100 with respect to what the device 100 is being placed on, or attached to, or worn by, based on the obtained inertial measurement data. For example, the device 100 i.e., the smart headwear uses the recorded data to estimate wearing style or position of said headwear in relation to its user.

There are different ways to estimate the placement and/or directionality of the device 100.

According to some embodiments herein, the device 100 may be configured to estimate placement and/or directionality of the device by being configured to analyze a movement pattern of a user wearing the device, which is extracted from the obtained inertial measurement data. For example, the estimation may be realized by analyzing the user's walking pattern which is extracted from the recorded data or by analyzing the user's head movement pattern which is extracted from the recorded data.

According to some embodiments herein, the device 100 may be configured to estimate placement and/or directionality of the device by being configured to compare the obtained inertial measurement data of the device 100 with data from an inertial measurement sensor integrated in smart clothes and/or shoes of the user. For example, multiple IMUs may be used, one IMU may be integrated in the smart headwear device, another IMU may be integrated in smart clothes and/or smart shoes of the user which indicates the direction aligning with user's face. One can check whether the smart headwear IMU data is in line with the smart clothes IMU data to estimate the placement and/or directionality of the device 100. Communications have to be set up to share the IMU data between the multiple IMUs.

According to some embodiments herein, the device 100 may be configured to estimate placement and/or directionality of the device by being configured to estimate the placement and/or directionality of the device by using a smart mirror having Bluetooth capabilities or using a user equipment, e.g. a phone or a mobile device, having front facing camera and/or Bluetooth capabilities. The smart mirror or a mobile device may be used to calibrate the smart headwear device. For example, the smart mirror or a phone camera may be used to detect user's face so that the IMU orientation of the smart headwear device corresponding to the face direction can be decided. Then the IMU of the smart headwear device can detect the placement and/or directionality change after the calibration. For another example, the mobile device may use its camera to detect and recognize the smart headwear device and detect or estimate said headwear device's placement in relation to its user.

According to some embodiments herein, the device 100 may comprise a radar 170 with antenna. The device 100 may be configured to estimate placement and/or directionality of the device by being configured to scan by the radar 170 to detect the placement and/or directionality of the device 100 with respect to what the device is being placed on, or attached to, or worn by. For example, the device 100 may include a low-cost low-power radar whose antenna points downwards, e.g. a smart headwear device has a radar located on the brim side. By scanning downward, the radar can detect if the wearer's face is under the brim or not. The device 100 can then detect that the Bluetooth antenna array or the sub-array on the brim side is in line with the wearer's face direction. Using said information the device 100 can disable the Bluetooth antenna array or the sub-array which is located on the rear side of the headwear device to save power.

According to embodiments herein, the device 100 is further configured to adapt, by means of the controller 110 being configured to, the operation of the device 100 based on the estimated placement and/or directionality of the device 100.

There are several options to adapt the operation of the device 100 based on the estimated placement and/or directionality of the device 100 for low power operations and optimal directional capabilities.

According to some embodiments, the device 100 may be configured to interact, position or communicate with other equipment or devices. As described above, the one or more antenna arrays or antenna sub-arrays in the device 100 may be distributed at different locations of the device 100. The device 100 may be configured to adapt the operation of the device based on the estimated placement and/or directionality of the device 100 by being configured to enable or disable one or more antenna arrays or sub-arrays based on the estimated placement and/or directionality of the device 100 in order to interact, position or communicate with the other equipment or devices in a certain direction.

For example, the device 100 may enable or disable directional antennas for location or directional positioning other equipment or devices that a user wearing the device 100 is controlling, when the other equipment or devices are mainly using the antennas in said device 100 to understand when said user is facing towards other equipment or devices, e.g. a TV, stereo, etc.

According to some embodiments herein, the device 100 may be configured to dynamically enabling or disabling the antenna arrays or sub-arrays based on the movement of what the device is being placed on, or attached to, or worn by. For example, the device 100 may dynamically enable/disable antenna arrays or sub-arrays according to user's pose and applications. For example, the device 100 may set up communication link with an IoT device in a user's face direction via the front facing antenna array or sub-array. When the user turns with his back to the IoT device, to continuously transfer data to the device, the device enables the back facing antennas and disables the front facing antennas.

According to some embodiments herein, the device 100 may be glasses, e.g. Extended Reality (XR) glasses, that uses the device placement information in relation to the user to enable/disable antenna array elements so as to optimize said antenna array for low power, directionality, etc. The glasses may e.g. be placed for usage resting on the user's nose or put resting on top of said user's head or hat or helmet.

According to some embodiments herein, the device 100 may be a headset. The device 100 may be configured to adapt the operation of the device based on the estimated placement and/or directionality of the device by being configured to assign right and left speaker outputs based on the estimated placement and/or directionality of the headset with respect to a user the headset is worn by. For example, the user may place an audio headset on his/her head without looking at the headset for reference on what's supposed to be right part of headset and left part of headset. The headset can deduct the placement and assign right and left speaker outputs accordingly.

According to some embodiments herein, the device 100 may be a generic bike light. The device 100 may be configured to adapt the operation of the device based on the estimated placement and/or directionality of the device 100 by being configured to adapt the bike light as a front light or a rear light based on the estimated placement and/or directionality of the bike light with respect to a bike the bike light is being placed on or attached to. For example, the generic bike light may adapt itself and take the role as front light typically white light or rear light typically red light after its placement.

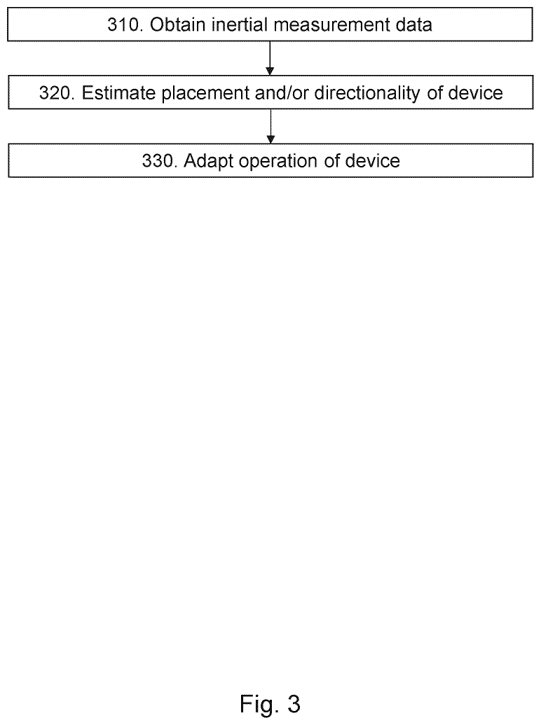

A method performed by the device 100 according to embodiments herein for adapting its operation to optimize operation power and directional capabilities will be described with reference to FIG. 3. The method comprises the following actions.

### Action 310

The device 100 obtains inertial measurement data measured by one or more sensors comprised in the device 100.

### Action 320

The device 100 estimates placement and/or directionality of the device 100 with respect to what the device 100 is being placed on, or attached to, or worn by, based on the obtained inertial measurement data.

According to some embodiments herein, the device 100 may analyze a movement pattern of a user wearing the device, which is extracted from the obtained inertial measurement data to estimate the placement and/or directionality of the device 100.

According to some embodiments herein, the device 100 may compare the obtained inertial measurement data with data from an inertial measurement sensor integrated in smart clothes and/or shoes of the user to estimate the placement and/or directionality of the device 100.

According to some embodiments herein, the device 100 may analyze a head movement pattern of the user wearing the device, which is extracted from the obtained inertial measurement data to estimate the placement and/or directionality of the device 100.

According to some embodiments herein, the device 100 may use a smart mirror having directional Bluetooth capabilities to estimate the placement and/or directionality of the device 100.

According to some embodiments herein, the device 100 may use a user equipment having front facing camera and directional Bluetooth capabilities to estimate the placement and/or directionality of the device 100.

According to some embodiments herein, the device 100 may scan by the radar 170 to detect the placement and/or directionality of the device with respect to what the device is being placed on, or attached to, or worn by.

### Action 330

The device 100 adapts the operation of the device 100 based on the estimated placement and/or directionality of the device 100.

According to some embodiments herein, the device 100 may enable or disable one or more antenna arrays AT1, AT2, AT3, AT4 or sub-arrays ATEs based on the estimated placement and/or directionality of the device 100 with respect to what the device 100 is being placed on, or attached to, or worn by in order to interact, position or communicate with the other equipment in a certain direction.

According to some embodiments herein, the device 100 may dynamically enable or disable the antenna arrays AT1, AT2, AT3, AT4 or sub-arrays ATEs based on the movement of what the device 100 is being placed on, or attached to, or worn by.

According to some embodiments herein, the device 100 may be a headset and the device 100 may assign right and left speaker outputs based on the estimated placement and/or directionality of the headset with respect to a user the headset is worn by.

According to some embodiments herein, the device 100 may be a generic bike light and the device 100 may adapt the bike light as a front light or a rear light based on the estimated placement and/or directionality of the bike light with respect to a bike the bike light is being placed on or attached to.

The embodiments herein may be implemented through one or more processors, such as the processor 120 in the device 100 together with computer program code 180, as shown in FIG. 1, for performing the functions and actions of the embodiments herein. The program code 180 may also be provided as a computer program product 190, for instance in the form of a data carrier carrying computer program code for performing the embodiments herein when being loaded into the device 100. The computer program code may furthermore be provided as pure program code on a server or cloud and downloaded to the device 100.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1: A method performed by a device for adapting its operation, the method comprising:
obtaining inertial measurement data;
estimating placement and/or directionality of the device with respect to what the device is being placed on, or attached to, or worn by, based on the obtained inertial measurement data; and
adapting the operation of the device based on the estimated placement and/or directionality of the device.

2: The method according to claim 1, wherein the device comprises a receiver and/or a transmitter with one or more antenna arrays or antenna sub-arrays for interacting, positioning or communicating with other equipment, wherein the one or more antenna arrays or antenna sub-arrays are distributed at different locations of the device, and wherein adapting the operation of the device based on the estimated placement and/or directionality of the device comprises:
enabling or disabling one or more antenna arrays or sub-arrays based on the estimated placement and/or directionality of the device with respect to what the device is being placed on, or attached to, or worn by in order to interact, position or communicate with the other equipment in a certain direction.

3: The method according to claim 2 further comprising dynamically enabling or disabling the antenna arrays or sub-arrays based on the movement of what the device is being placed on, or attached to, or worn by.

4: The method according to claim 1, wherein the device is a headwear device and wherein estimating the placement and/or directionality of the device comprises any one or a combination of:
analyzing a movement pattern of a user wearing the device, which is extracted from the obtained inertial measurement data;
comparing the obtained inertial measurement data with data from an inertial measurement sensor integrated in smart clothes and/or shoes of the user.

5: The method according to claim 4, wherein analyzing a movement pattern comprises analyzing a head movement pattern of the user wearing the device, which is extracted from the obtained inertial measurement data.

6: The method according to claim 1, wherein estimating the placement and/or directionality of the device comprises any one or a combination of:
using a smart mirror having directional Bluetooth capabilities;
using a user equipment having front facing camera and directional Bluetooth capabilities.

7: The method according to claim 1, wherein the device comprises a radar with antenna and wherein estimating the placement and/or directionality of the device comprises scanning by the radar to detect the placement and/or directionality of the device with respect to what the device is being placed on, or attached to, or worn by.

8: The method according to claim 1, wherein the device is a headset, and wherein adapting the operation of the device based on the estimated placement and/or directionality of the device comprises assigning right and left speaker outputs based on the estimated placement and/or directionality of the headset with respect to a user the headset is worn by.

9: The method according to claim 1, wherein the device is a generic bike light, and wherein adapting the operation of the device based on the estimated placement and/or directionality of the device comprises adapting the bike light as a front light or a rear light based on the estimated placement and/or directionality of the bike light with respect to a bike the bike light is being placed on or attached to.

10: A device comprising a controller, a processor, one or more sensors and a memory, the device is configured to:
obtain, by means of the one or more sensors being configured to, inertial measurement data;
estimate, by means of the processor being configured to, placement and/or directionality of the device with respect to what the device is being placed on, or attached to, or worn by; and
adapt, by means of the controller be configured to, the operation of the device based on the estimated placement and/or directionality of the device.

11: The device according to claim 10, wherein the device is configured to estimate placement and/or directionality of the device by being configured to any one or a combination of:
analyze a movement pattern of a user wearing the device, which is extracted from the obtained inertial measurement data;
compare the obtained inertial measurement data of the device with data from an inertial measurement sensor integrated in smart clothes and/or shoes of the user.

12: The device according to claim 11, wherein the device is further configured to analyze a head movement pattern of a user wearing the device.

13: The device according to claim 10, wherein the device is configured to estimate placement and/or directionality of the device by being configured to any one or a combination of:
use a smart mirror having directional Bluetooth capabilities;
use a mobile device having front facing camera and directional Bluetooth capabilities.

14: The device according to claim 10, wherein the device further comprises a radar with antenna and wherein the device is configured to estimate placement and/or directionality of the device by being configured to scan by the radar to detect the placement and/or directionality of the device with respect to what the device is being placed on, or attached to, or worn by.

15: The device according to claim 10, wherein the device comprises a receiver and/or a transmitter with one or more antenna arrays or antenna sub-arrays for interacting, positioning or communicating with other equipment, wherein the one or more antenna arrays or antenna sub-arrays are distributed at different locations of the device, and wherein the device is configured to adapt the operation of the device based on the estimated placement and/or directionality of the device by being configured to:
enable or disable one or more antenna arrays or sub-arrays based on the estimated placement and/or directionality of the device in order to interact, position or communicate with the other equipment in a certain direction.

16: The device according to claim 15 is further configured to dynamically enabling or disabling the antenna arrays or sub-arrays based on the movement of what the device is being placed on, or attached to, or worn by.

17: The device according to claim 10, wherein the device is a headset, and wherein the device is configured to adapt the operation of the device based on the estimated placement and/or directionality of the device by being configured to assign right and left speaker output based on the estimated placement and/or directionality of the headset with respect to a user the headset is worn by.

18: The device according to claim 10, wherein the device is a generic bike light, and wherein the device is configured to adapt the operation of the device based on the estimated placement and/or directionality of the device by being configured to adapt the bike light as a front light or a rear light based on the estimated placement and/or directionality of the bike light with respect to a bike the bike light is being placed on or attached to.

19: The device according to claim 10, wherein the device is headwear device comprising any one of a smart cap, a smart wig, a smart glasses, a smart hat, a smart scarf, a smart headband, a smart hair band.
